(19) United States
(12) Patent Application Publication
(10) Pub. No.: US 2005/0209952 A1
(43) Pub. Date: Sep. 22, 2005

(54) System and method for controlling electronic bidding across different time zones

(76) Inventors: Sumiko Takahashi, Tokyo (JP); Venkatesan Kanna, Walldorf (DE)

Correspondence Address: Finnegan, Henderson, Farabow,;Garrett & Dunner, L.L.P., 1300 I Street, N.W., Washington, DC, 20005-3315, US

(21) Appl. No.: 10/892,378

(22) Filed: Jul. 16, 2004

(30) Foreign Application Priority Data
Jul. 18, 2003 (JP) 2003-277146

(51) Int. Cl. G06F 17/60

(52) U.S. Cl. 705/37

(57) ABSTRACT

A system and method for controlling bids between buyers and sellers accounts for differences in time zones between participants. In a buyer terminal, a buyer appoints a provisory bid closing time prior to a bid closing time. A bid control system computes a time of a specified preliminarily closing time in a time zone to which a nominated trader belongs. Supplier terminals display the computed time as the bid closing time.

### TECHNICAL FIELD

The present invention generally relates to controlling computerized bids between purchasers and sellers. More specifically, the present invention relates to a system and method that controls electronic bidding via a network such as the Internet across different time zones.

### RELATED APPLICATIONS

Priority is claimed to Japanese Patent Application No. 2003-277146 filed on Jul. 18, 2003, the content of which is incorporated herein by reference.

### BACKGROUND

In a typical commercial transaction between purchasers and sellers, sellers submit bids according to a rule, and those who present the most advantageous terms wins the contract with the purchaser. In some cases, however, a bidding form is adopted where a buyer nominates a bid participating trader on his/her side. Recently, this kind of bidding has been electronically conducted via the Internet or the like.

In a bidding system where bidding is electronically conducted via the Internet or the like (appropriately called an electronic bidding system), a buyer sends data notifying a trader of a bid nomination from the buyer terminal to the trader terminal. The nominated trader who sees this on the trader terminal deliberates whether to participate or not based on the bid nomination notification data. In the case where the trader decides to participate, the trader sends a bid price to the buyer terminal via the Internet during the period from the bid starting time to the bid closing time.

When the bid closing date has past, the buyer discontinues participation in the bidding, and decides on an order with a nominated trader who submitted the lowest price among all the presented bid prices. The buyer then sends its decision to the trader terminal of the successful trader via the Internet (refer to Japanese Unexamined Patent Application, First Publication No. 2001-184433 for example). In such electronic bidding systems, it is also assumed that after the nominated trader has participated in the bidding, price adjustment will be made via the Internet between the buyer and the nominated trader.

However, with the progress of internationalization, the buyer and the nominated trader are not always limited to those in the same time zone. In other words, the local time of the buyer and the local time of the nominated trader may be different. Therefore, where the bidding time appointed by the buyer (bid starting time to the bid closing time) is displayed on the trader terminal, even if the bid price is sent to the buyer within the displayed bidding time, the bid closing time may have passed and it may be impossible to participate in the bidding.

Moreover, the nominated trader has many things to examine before the bid closing time draws near, for example, whether to participate in the bidding, how much should the bid price be if participating, and so on. In such a case, it might happen that the bid closing time has expired while the price is being adjusted between the buyer and the nominated traders participating in the bidding.

### SUMMARY

In one aspect consistent with principles of the present invention, a bid control system connected to a buyer terminal on a buyer side and a supplier terminal on a supplier side via a network in order to control bidding includes a supplier information storage section, a bid request edit page offering section, a bid closing time computing section, and a bid request guide page. The supplier information storage section stores an identifier for the supplier and a time zone for the supplier. The bid request edit page offering section offers information related to a bid request edit page including a principal bid closing time as an input item, to the buyer terminal. The bid closing time computing section specifies a time zone for a nominated trader related with an identifier of the nominated trader by referring to storage information of the supplier information storage section. The bid closing time computing section also computes a time of a principal bid closing time appointed by the buyer in the time zone for the nominated trader using the bid request edit page, based on the time zone for the nominated trader and the time zone for the buyer to whom the bid request edit page is offered by the bid request edit page offering section. The bid request guide page offering section offers to the supplier terminal of the nominated trader, a bid request guide page in which a displayed bid closing time is the time computed by the bid closing time computing section.

The bid closing time computing section computes the time of the principal bid closing time appointed by the buyer in the time zone for the nominated trader, using the bid request edit page offered to the buyer terminal by the bid request edit page offering section, based on the time zone for the buyer and the time zone for the nominated trader. Then, the bid closing time displayed in the bid request guide page offered to the supplier terminal of the nominated trader by the bid request guide page offering section is the time computed by the bid closing time computing section. As a result, the bid closing time is displayed as the time of one's own time zone, so that nominated traders can be prevented from bidding after the bid closing time has passed.

In the bid control system, the bid request edit page may further include a provisory bid closing time prior to the principal bid closing time, as an input item. Moreover, the bid closing time computing section computes a time of the provisory bid closing time in the time zone for the nominated trader instead of the principal bid closing time.

Accordingly, the bid closing time displayed in the bid request guide page offered to the supplier terminal of the nominated trader by the bid request guide page offering section is the provisory bid closing time prior to the principal bid closing time. As a result, there is a period from the time displayed to the nominated trader to the time when the bidding is closed, so that adjustment between the buyer and the nominated trader can be conducted to the last minute.

In another aspect consistent with the principles of the present invention, a bid control method conducted in a bid control system connected to a buyer terminal on a buyer side and a supplier terminal on a supplier side via a network comprises storing an identifier for identifying the supplier and a time zone for the supplier, and offering to the buyer terminal information related to a bid request edit page including a principal bid closing time which closes bidding as an input item. The method further comprises specifying a time zone for a nominated trader related with an identifier of the nominated trader among the suppliers by referring to information stored in the supplier information storing step, and computing a time of a principal bid closing time appointed by the buyer in the time zone the nominated trader using the bid request edit page, based on the time zone for the nominated trader and the time zone for the buyer to whom the bid request edit page is offered in the bid request edit page offering step. Finally, the method includes offering to the supplier terminal of the nominated trader a bid request guide page in which a displayed bid closing time is the time computed in the bid closing time computing step.

Accordingly, the method computes the time of the principal bid closing time appointed by the buyer in the time zone for the nominated trader, using the bid request edit page offered to the buyer terminal in the bid request edit page offering step, based on the time zone for the buyer and the time zone for the nominated trader. Then, the bid closing time displayed in the bid request guide page offered to the supplier terminal of the nominated trader in the bid request guide page offering step is the time computed in the bid closing time computing step. As a result, the bid closing time is displayed as the time of one's own time zone, so that the nominated trader can be prevented from bidding after the bid closing time has passed.

In the bid control method, the bid request edit page may further include a provisory bid closing time prior to the principal bid closing time, as an input item. Moreover, the bid closing time computing step computes a time of the provisory bid closing time in the time zone for the nominated trader instead of the principal bid closing time.

Accordingly, the bid closing time displayed in the bid request guide page offered to the supplier terminal of the nominated trader by the bid request guide page offering step is the provisory bid closing time prior to the principal bid closing time. As a result, there is a period from the time displayed to the nominated trader to the time when the bidding is closed, so that the adjustment between the buyer and the nominated trader can be conducted to the last minute.

In a further aspect consistent with the principles of the present invention, a computer-readable medium stores a set of instructions for controlling bids in a bid control system connected to a buyer terminal on a buyer side and a supplier terminal on a supplier side via a network. When executed on a computer, the instructions perform stages including storing an identifier for the supplier and a time zone for the supplier, and offering to the buyer terminal information related to a bid request edit page including a principal bid closing time which closes bidding as an input item. The performed stages also include specifying a time zone for a nominated trader related with an identifier of the nominated trader among the suppliers by referring to storage information of the supplier information storage section, and computing a time of a principal bid closing time appointed by the buyer in the time zone for the nominated trader using the bid request edit page, based on the time zone for the nominated trader and the time zone for the buyer to whom the bid request edit page is offered by the bid request edit page offering section. Finally, the performed stages include offering to the supplier terminal of the nominated trader a bid request guide page in which a displayed bid closing time is the time computed by the bid closing time computing section.

Accordingly, the instructions on the computer-readable medium, when executed, compute the time of the principal bid closing time appointed by the buyer in the time zone for the nominated trader, using the bid request edit page offered to the buyer terminal by the bid request edit page offering section, based on the time zone for the buyer and the time zone for the nominated trader. Then, the bid closing time displayed in the bid request guide page offered to the supplier terminal of the nominated trader by the bid request guide page offering section is the time computed by the bid closing time computing section. As a result, the bid closing time is displayed as the time of one's own time zone, so that the nominated traders can be prevented from bidding after the bid closing time has passed.

In the performed stages of this computer-readable medium, the bid request edit page may further include a provisory bid closing time prior to the principal bid closing time, as an input item. Moreover, the bid closing time computing section computes a time of the provisory bid closing time in the time zone for the nominated trader instead of the principal bid closing time.

Accordingly, the bid closing time displayed in the bid request guide page offered to the supplier terminal of the nominated trader by the bid request guide page offering section is the provisory bid closing time prior to the principal bid closing time. As a result, there is a period from the time displayed to the nominated trader to the time when the bidding is closed, so that adjustment between the buyer and the nominated trader can be conducted to the last minute.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 is a block diagram of an electronic bidding system in an embodiment.

FIG. 2 is a functional diagram for explaining the functions of a bid control system.

FIG. 3 is a flowchart showing a flow of bid processing (No.1).

FIG. 4 is a flowchart showing a flow of bid processing (No. 2).

FIG. 5 is a sequence diagram showing a flow of bid processing (No. 1).

FIG. 6 is a sequence diagram showing a flow of bid processing (No. 2).

FIG. 7 is a sequence diagram showing a flow of bid processing (No. 3).

FIG. 8 is a sequence diagram showing a flow of bid processing (No. 4).

FIG. 9 shows an example of a bid request edit page.

FIG. 10 shows an example of a bid request guide page for editing.

FIG. 11 shows an example of a bid contents confirmation page.

FIG. 12 shows an example of a bid contents edit page.

### DETAILED DESCRIPTION

The following description refers to the accompanying drawings in which, in the absence of a contrary representation, the same numbers in different drawings represent similar elements. The implementations in the following description do not represent all implementations consistent with principles of the claimed invention. Instead, they are merely some examples of systems and methods consistent with those principles. It is to be understood that both the foregoing general description and the following detailed description are exemplary and explanatory only and are not restrictive of the invention, as claimed.

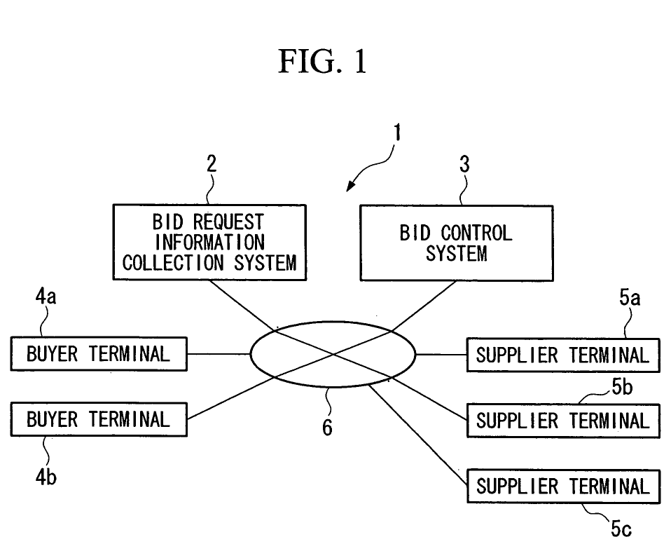

FIG. 1 is a block diagram showing an outline of an electronic bidding system in the present embodiment. As shown in FIG. 1, an electronic bidding system 1 contains a bid request information collection system 2, a bid control system 3, buyer terminals 4a and 4b provided on the buyers' side, and supplier terminals 5a, 5b and 5c provided on the suppliers' side, which are mutually connected via the Internet 6. The number of the buyer terminals and the supplier terminals is appropriately modified corresponding to the scale of the electronic bidding system. Moreover, needless to say, the electronic bidding system may be constructed using a network besides the Internet.

The bid request information collection system 2 collects various information necessary for a bid request (hereunder, bid request information), which is provided by a system not shown. Then, the bid request information collection system 2 passes the collected bid request information to the bid control system 3. Examples of information necessary for a bid request are information of the buyer, information of parts requested to be supplied, information of the suppliers (nominated traders) requested to supply, time zone code of the time zone of the buyer, and the like.

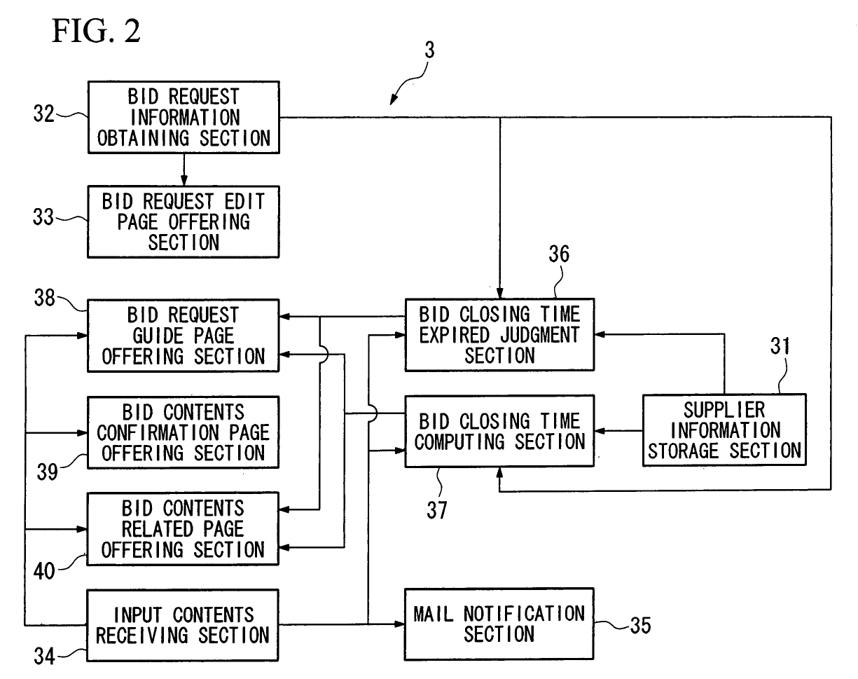

The bid control system 3 conducts the overall administration related to the bidding and has functions such as shown in FIG. 2. FIG. 2 is a functional diagram for explaining the functions of the bid control system.

As shown in FIG. 2, the bid control system 3 has a supplier information storage section 31, a bid request information obtaining section 32, a bid request edit page offering section 33, an input contents receiving section 34, a mail notification section 35, a bid closing time expired judgment section 36, a bid closing time computing section 37, a bid request guide page offering section 38, a bid contents confirmation page offering section 39, and a bid contents related page offering section 40.

The supplier information storage section 31 stores by relating with the supplier ID of the supplier (same as the user ID of the supplier in the present embodiment) and the time zone code of the time zone of the supplier.

The bid request information obtaining section 32 obtains the bid request information passed from the bid request information collection system 2 and stores it.

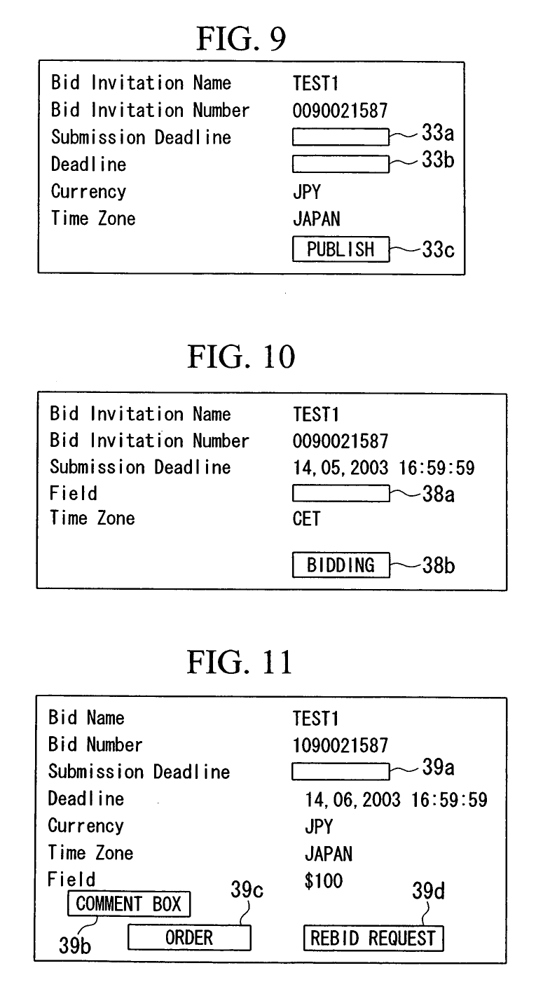

The bid request edit page offering section 33 offers the information related to the bid request edit page, which is for the buyer to request bidding to the nominated traders, to the buyer terminals 4a and 4b used by the buyer included in the bid request information obtained by the bid request information obtaining section 32. As shown in the example in FIG. 9, this bid request edit page contains a box (Deadline) 33b for inputting the bid closing time when the buyer closes the bidding (hereunder, called the principal bid closing time), a box (Submission Deadline) 33a for inputting the time prior to the principal bid closing time (hereunder, called the provisory bid closing time), and a button (Publish) 33c for clicking when decided. FIG. 9 shows the necessary parts for explaining the present embodiment. However, the information used for offering this bid request edit page is stored, and the information related to the bid request edit page is offered to the buyer terminal based on this stored information and the bid request information.

The input contents receiving section 34 receives the input contents that the buyer input using the bid request edit page or the bid contents confirmation page, from the buyer terminals 4a and 4b. Moreover, the input contents receiving section 34 receives the input contents which the nominated traders input using the bid request guide page for editing or the bid contents edit page, from the supplier terminals 5a, 5b, and 5c.

When the mail notification section 35 receives edit contents and input contents from the buyer terminals 4a and 4b that were offered the information related to the bid request edit page, it sends the bid request notification mail, which notifies of the bid request, to the nominated traders included in the bid request information. Moreover, when the mail notification section 35 receives the input contents (order) from the buyer terminals 4a and 4b that were offered the information related to the bid contents confirmation page, it sends the order notification mail, which notifies the decision of party to be given the order, to the nominated trader that bid for the order target. Moreover, when the mail notification section 35 receives the input contents (rebid request) from the buyer terminals 4a and 4b that were offered the information related to the bid contents confirmation page, it sends the rebid request notification mail, which notifies of the rebid request, to the nominated trader that bidded for the target of the rebid request.

When the mail notification section 35 receives the input contents from the supplier terminals 5a, 5b and 5c that were offered the information related to the bid `request guide page for editing, it sends the bid notification mail, which notifies of the bidding, to the buyer included in the bid request information. Moreover, when the mail notification section 35 receives the input contents from the supplier terminals 5a, 5b and 5c that were offered the information related to the bid contents edit page, it sends the rebid notification mail, which notifies of the rebidding, to the buyer included in the bid request information.

The bid closing time expired judgment section 36 refers to the supplier information storage section 31 and specifies the time zone code of this nominated trader based on the user ID (supplier ID) that was input when the nominated trader was connecting to the bid control system 3. Then, based on the time zone code of the buyer included in the bid request information and the specified time zone code of the nominated trader, the time in the time zone of the buyer corresponding to the time when the nominated trader connected to the bid control system 3 is computed. Then, the bid closing time expired judgment section 36 compares the computed time with the principal bid closing time appointed by the buyer using the bid request edit page, and judges whether or not the nominated trader connected to the bid control system 3 prior to the principal bid closing time based on the compared result.

The bid closing time computing section 37 refers to the supplier information storage section 31 and specifies the time zone code of this nominated trader based on the user ID (supplier ID) that was input when the nominated trader was connecting to the bid control system 3. Then, based on the time zone code of the buyer included in the bid request information and the specified time zone code of the nominated trader, the time is computed for the time zone of the nominated trader who connected to the bid control system 3 of the provisory bid closing time that the buyer appointed using the bid request edit page.

When it is judged by the bid closing time expired judgment section 36 that the nominated trader had connected prior to the principal bid closing time, the bid request guide page offering section 38 offers the information related to the bid request guide page for editing, which is for the nominated trader to participate in the bidding, to the supplier terminals 5a, 5b and 5c. As shown in the example in FIG. 10, this bid request guide page for editing contains a box (Submission Deadline) for showing the bid closing time to the nominated traders, a box (Field) 38a for inputting the bid price for example, and a button (Bidding) 38b for clicking when sending. Here, the displayed bid closing time is related to the provisory bid closing time appointed using the bid request edit page (not related to the principal bid closing time), and also the time after the modification into the time zone of the nominated trader. FIG. 10 shows necessary parts for explaining the present embodiment.

Here, information used for offering this bid request guide page for editing is stored and, based on this stored information, the contents that were input using the bid request edit page, and the computed result by the bid closing time computing section 37, the information related to the bid request guide page for editing is offered to the supplier terminal.

Moreover, when it is judged by the bid closing time expired judgment section 36 that the nominated trader had connected after the principal bid closing time, the bid request guide page offering section 38 offers the information related to the bid request guide page for referencing to the supplier terminals 5a, 5b and 5c. This page is for the nominated trader to reference the contents of the bid request. This bid request guide page for referencing contains a box (Submission Deadline) for showing the bid closing time to the nominated traders. The bidding cannot be conducted in this bid request guide page for referencing.

Here, information used for offering this bid request guide page for referencing is stored and, based on this stored information, the contents that were input using the bid request edit page, and the computed result by the bid closing time computing section 37, the information related to the bid request guide page for referencing is offered to the supplier terminal.

The bid contents confirmation page offering section 39 offers the information related to the bid contents confirmation page, which is for the buyer to confirm the contents of the bidding or the rebidding conducted by the nominated traders, to the buyer terminals 4a and 4b used by the buyer included in the bid request information. As shown in the example in FIG. 11, this bid contents confirmation page contains a box (Submission Deadline) 39a for inputting the provisory bid closing time, a box 39b for inputting the comments with respect to the bidding, a button (Order) 39c for clicking when ordering, and a button (Rebid request) 39d for clicking when requesting rebidding. Moreover, the bid price that was were input by the nominated trader, is displayed in a display box (Field). FIG. 11 shows the necessary parts for explaining the present embodiment.

Here, information used for offering this bid contents confirmation page is stored, and based on this stored information, and the contents that were input using the bid request guide page for editing and the bid request edit page, the information related to the bid contents confirmation page is offered to the buyer terminal.

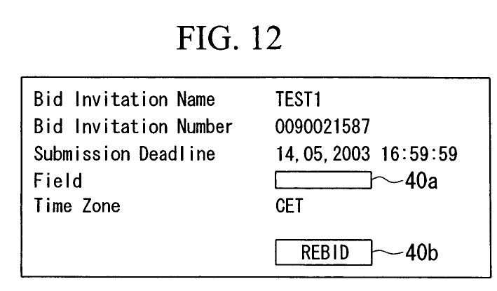

When it is judged by the bid closing time expired judgment section 36 that the nominated trader had connected prior to the principal bid closing time, the bid contents related page offering section 40 offers the information related to the bid contents edit page, which is for the nominated trader to rebid, to the supplier terminals 5a, 5b and 5c. As shown in the example in FIG. 12, this bid contents edit page contains a box (Submission Deadline) for showing the bid closing time to the nominated traders, a box (Field) 40a for reinputting the bid price for example, and a button (Rebidding) 40b for clicking when sending. Here, the displayed bid closing time is related to the provisory bid closing time appointed using the bid contents confirmation page (not related to the principal bid closing time), and also the time after the modification into the time zone of the nominated trader. FIG. 12 shows the necessary parts for explaining the present embodiment.

Here, information used for offering this bid contents edit page is stored, and, based on this stored information, the contents that were input using the bid contents confirmation page, and the computed result by the bid closing time computing section 37, the information related to the bid contents edit page is sent to the supplier terminal.

Moreover, when it is judged by the bid closing time expired judgment section 36 that the nominated trader had connected after the principal bid closing time, the bid contents related page offering section 40 offers the information related to the bid contents reference page to the supplier terminals 5a, 5b and 5c. The bidding cannot be conducted in this bid request guide page for referencing.

Here, information used for offering this bid contents reference page is stored and, based on this stored information, the contents that were input using the bid contents confirmation page, and the computed result by the bid closing time computing section 37, the information related to the bid contents reference page is offered to the supplier terminal.

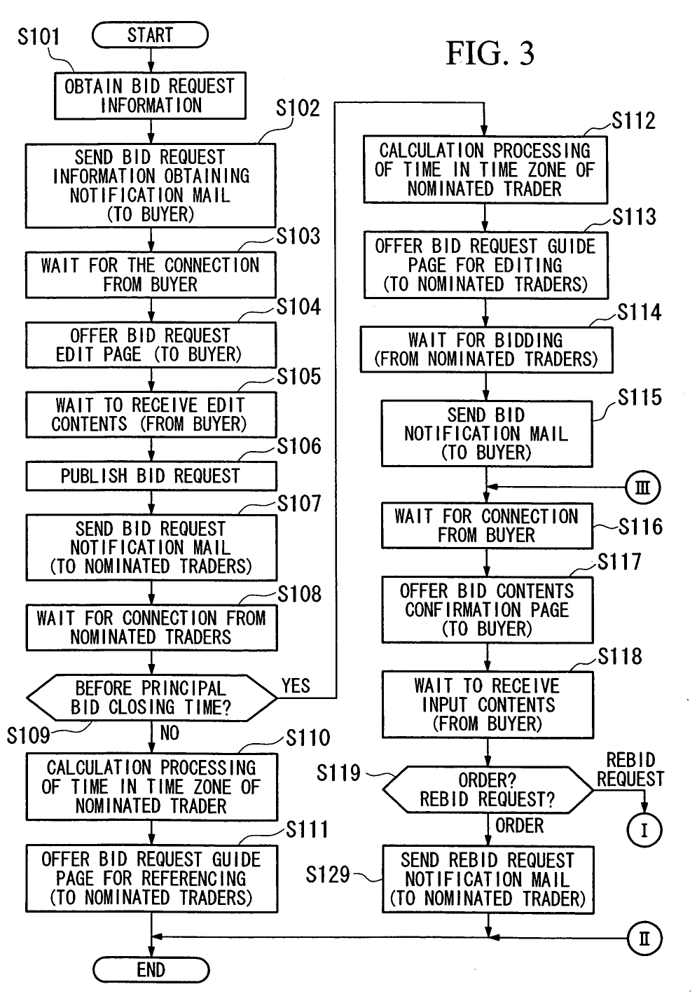

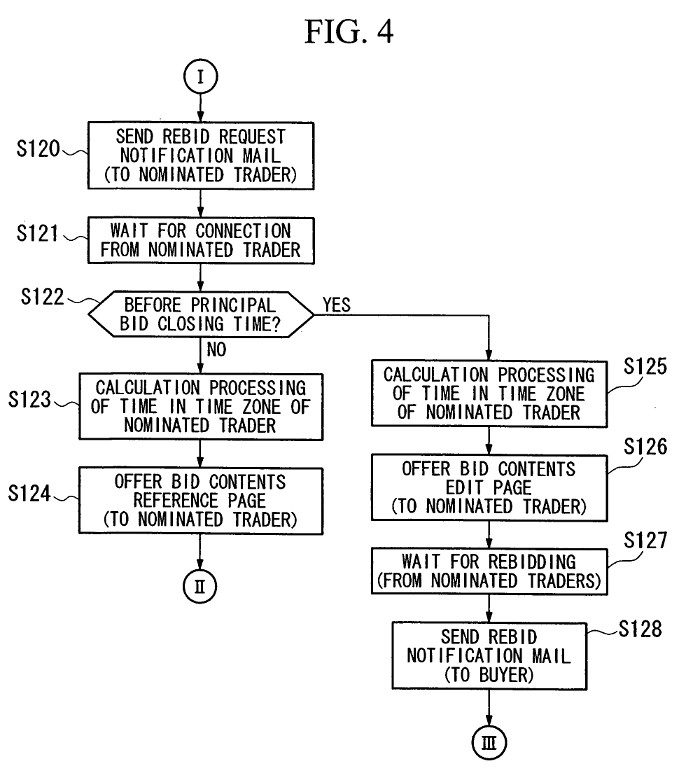

FIG. 3 and FIG. 4 are flowcharts showing flows of bid processing conducted in the bid control system of the electronic bidding system described above. In the description of flowcharts in FIG. 3 and FIG. 4, the description assumes that the buyer terminal is the buyer terminal 4a and the supplier terminal is the supplier terminal 5a. Even if the buyer terminal is another buyer terminal, the flowchart is substantially the same, and even if the supplier terminal is another supplier terminal, the flowchart is substantially the same.

The bid request information obtaining section 32 in the bid control system 3 obtains the bid request information passed from the bid request information collection system 2 and stores it (step S101). Subsequently, the mail notification section 35 sends the bid request information obtaining notification mail to the buyer included in the bid request information obtained in step S101 (step S102). Then, the bid control system 3 waits for the connection from the buyer (the buyer terminal 4a used by this buyer) who was sent the bid request information obtaining notification mail (step S103).

When the bid control system 3 is connected from the buyer terminal 4a used by this buyer who was sent the bid request information obtaining notification mail, the bid request edit page offering section 33 offers the information related to the bid request edit page to the buyer terminal 4a that has been connected (step S104). As a result, the bid request edit page, shown as an example in FIG. 9, is displayed in the display section of the buyer terminal 4a. Then, the buyer uses the bid request edit page and inputs the necessary items for requesting the bidding such as the principal bid closing time, the provisory bid closing time, and the like, and clicks the publish button after the input.

The bid control system 3 waits to receive the edit contents (contents that the buyer input using the bid request edit page) from the buyer terminal 4a, which was offered the information related to the bid request edit page (step S105). Then, when the edit contents are received from the buyer terminal 4a by the input contents receiving section 34, the bid control system 3 enables access to the bid request of one or a plurality of nominated traders included in the bid request information obtained in step S101. That is, it publishes the bid request (step S106). Subsequently, the mail notification section 35 sends the bid request notification mail to one or a plurality of nominated traders included in the bid request information obtained in step S101 (step S107). Then, the bid control system 3 waits for connection from one or a plurality of nominated traders (supplier terminals used by the nominated traders) who were sent the bid request notification mail (step S108). In some cases, a plurality of nominated traders connect to the bid control system 3, that is, participate in the bidding.

When the bid control system 3 is connected from the supplier terminal 5a used by any nominated trader who was sent the bid request notification mail, the bid closing time expired judgment section 36 judges if the time of the connection from the supplier terminal 5a used by the nominated trader, was before the principal bid closing time or not (step S109). Then, if judged to be before the principal bid closing time (S109: YES), the processing shifts to step S112. On the other hand, if judged to be after the principal bid closing time (S109: NO), the processing shifts to step S10.

In step S110, based on the time zone code of the buyer and the time zone code of the nominated trader who has connected (time zone code stored by the supplier information storage section 31 related with the user ID (supplier ID) that the nominated trader has input), the bid closing time computing section 37 computes the time in the time zone of the nominated trader for the provisory bid closing time appointed by the buyer using the bid request edit page (step S110). Subsequently, since it has passed the principal bid closing time, the bid request guide page offering section 38 offers the information related to the bid request guide page for referencing including the display of the bid closing time (time computed in step S110), to the supplier terminal 5a that has connected to the bid control system 3 (step S111), and the processing of FIG. 3 and FIG. 4 is finished. In this bid request guide page for referencing, the contents can only be referenced. That is, the nominated trader cannot participate in the bidding since it is after the principal bid closing time.

In step S112, based on the time zone code of the buyer and the time zone code of the nominated trader who has connected (time zone code stored by the supplier information storage section 31 related with the user ID (supplier ID) that the nominated trader has input), the bid closing time computing section 37 computes the time in the time zone of the nominated trader for the provisory bid closing time appointed by the buyer using the bid request edit page (step S112). Subsequently, since it is before the principal bid closing time, the bid request guide page offering section 38 offers the information related to the bid request guide page for editing including the display of the bid closing time (time computed in step S112), to the supplier terminal 5a that has connected to the bid control system 3 (Step S113). As a result, the bid request guide page for editing shown as an example in FIG. 10, is displayed in the display section of the supplier terminal 5a. Then, the nominated trader uses the bid request guide page for editing and inputs the necessary items for the bidding such as bid price or the like and then clicks the bid button after the input up until the bid closing time (time related to the provisory bid closing time after modification into the time zone of the nominated trader) displayed in the bid request guide page for editing.

The bid control system 3 waits to receive the edit contents from the supplier terminal 5a that was offered the information related to the bid request guide page for editing. That is, it waits for the bidding from the nominated trader (step S114). Then, when the edit contents are received from the supplier terminal 5a by the input contents receiving section 34, that is, when the nominated trader bids, the mail notification section 35 sends the bid notification mail to the buyer (step S115).

The bid control system 3 waits for the connection from the buyer terminal 4a used by the buyer who was sent the bid notification mail in step S115 or the buyer who was sent the rebid notification mail in step S128 (step S116).

When the bid control system 3 is connected from the buyer terminal 4a used by this buyer who was sent the bid notification mail or the rebid notification mail, the bid contents confirmation page offering section 38 offers the information related to the bid contents confirmation page to the buyer terminal 4a that has connected (step S117). As a result, the bid contents confirmation page shown as an example in FIG. 11, is displayed in the display section of the buyer terminal 4a. Then, the buyer refers to the bid contents confirmation page and examines the contents of the bidding conducted by the nominated trader. As a result of the examination, if it is decided that the nominated trader who made the bid is to be given the order, the buyer clicks the order button. On the other hand, as a result of the examination, if the contents of the bidding is desired to be modified, the buyer inputs the provisory bid closing time in the input box (Submission Deadline) for the provisory bid closing time and inputs a comment for desiring the modification in the comment box, and then clicks the rebid request button.

The bid control system 3 waits to receive the input contents (order: provisory bid closing time, comment, and rebid request) from the buyer terminal 4a that was offered the information related to the bid contents confirmation page (step S118).

Then, when the input contents are received from the buyer terminal, the bid control system 3 judges whether the buyer ordered or requested rebidding, based on the input contents (step S119). If it is judged as an order (S119: order), the processing shifts to step S129, and the mail notification section 35 sends the order notification mail to the nominated trader who conducted the bidding and who has become the target of the order (step S129), and finishes the processing of FIG. 3 and FIG. 4. On the other hand, if it is judged as a rebid request (S119: rebid request), the processing shifts to step S120.

In step S120, the mail notification section 35 sends the rebid request notification mail to the nominated trader who conducted the bidding and who has become the target of the rebid request (step S120). Then, the bid control system 3 waits for the connection from the nominated trader (the supplier terminal used by the nominated trader) who was sent the rebid request notification mail (step S121).

When the bid control system 3 is connected from the supplier terminal 5a used by the nominated trader who was sent the rebid request notification mail, the bid closing time expired judgment section 36 judges if the time of the connection from the supplier terminal 5a used by the nominated trader, was before the principal bid closing time or not (step S122). Then, if judged to be before the principal bid closing time (S122: YES), the processing shifts to step S125. On the other hand, if judged to be after the principal bid closing time (S122: NO), the processing shifts to step S123.

In step S123, based on the time zone code of the buyer and the time zone code of the nominated trader who has connected (time zone code stored by the supplier information storage section 31 related with the user ID (supplier ID) that the nominated trader has input), the bid closing time computing section 37 computes the time in the time zone of the nominated trader for the provisory bid closing time appointed by the buyer using the bid contents confirmation page (step S123). Subsequently, since it has passed the principal bid closing time, the bid contents related page offering section 40 offers the information related to the bid contents reference page including the display of the bid closing time (time computed in step S123) to the supplier terminal 5a that has connected to the bid control system 3 (step S124) and the processing of FIG. 3 and FIG. 4 is finished. In this bid contents reference page, the contents can only be referenced. That is, the nominated trader cannot rebid since it is after the principal bid closing time.

In step S125, based on the time zone code of the buyer and the time zone code of the nominated trader who has connected (time zone code stored by the supplier information storage section 31 related with the user ID (supplier ID) that the nominated trader has input), the bid closing time computing section 37 computes the time in the time zone of the nominated trader for the provisory bid closing time appointed by the buyer using the bid contents confirmation page (step S125). Subsequently, since it is before the principal bid closing time, the bid contents related page offering section 40 offers the information related to the bid contents edit page including the display of the bid closing time (time computed in step S125), to the supplier terminal 5a that has connected to the bid control system 3 (Step S126). As a result, the bid contents edit page shown as an example in FIG. 12, is displayed in the display section of the supplier terminal 5a. Then, the nominated trader uses the bid contents edit page and reinputs the necessary items for the rebidding such as the bid price or the like and then clicks the rebid button after the input up until the bid closing time (time related to provisory bid closing time after modification into the time zone of the nominated trader) displayed in the bid contents edit page.

The bid control system 3 waits to receive the input contents from the supplier terminal 5a. That is, it waits for the rebidding from the nominated trader (step S127). Then, when the input contents are received from the supplier terminal 5a by the input contents receiving section 34, that is, when the nominated trader rebids, the mail notification section 35 sends the rebid notification mail to the buyer (step S128) and the processing shifts to step S116.

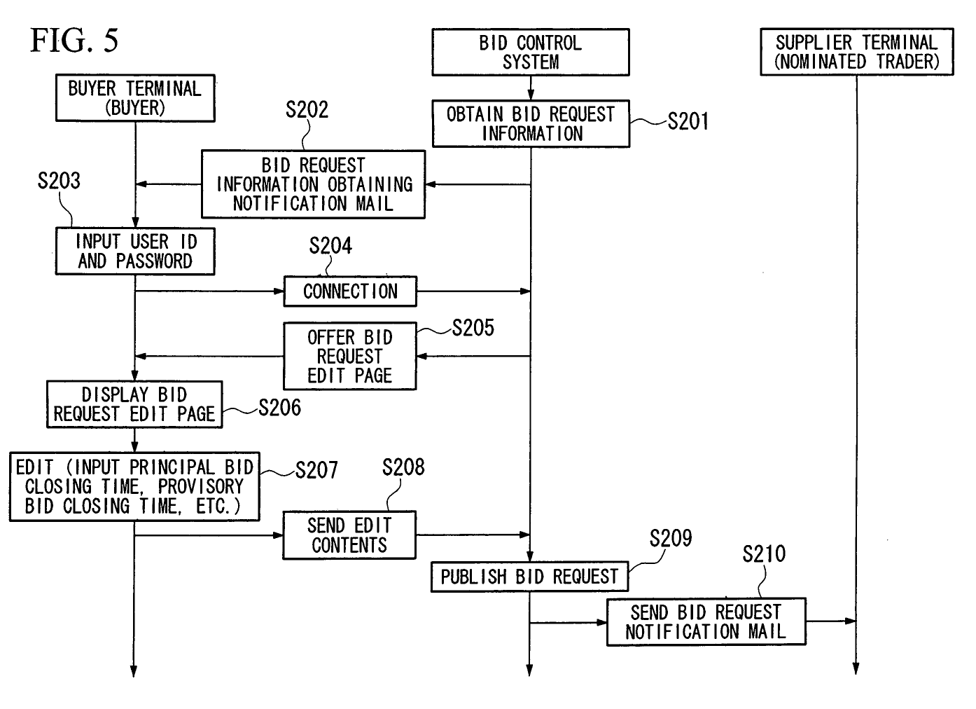

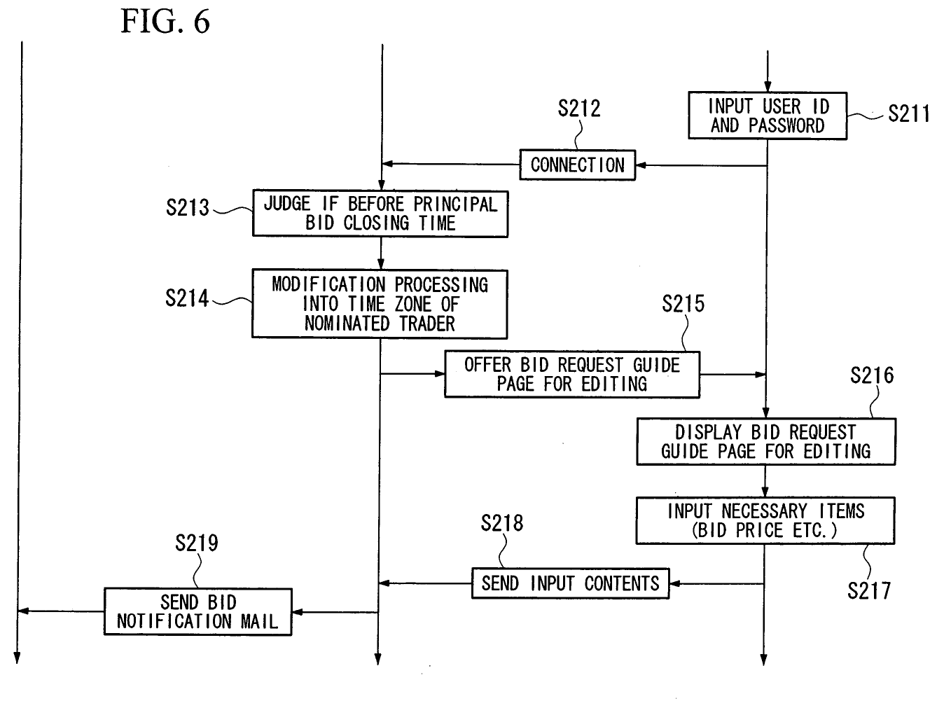

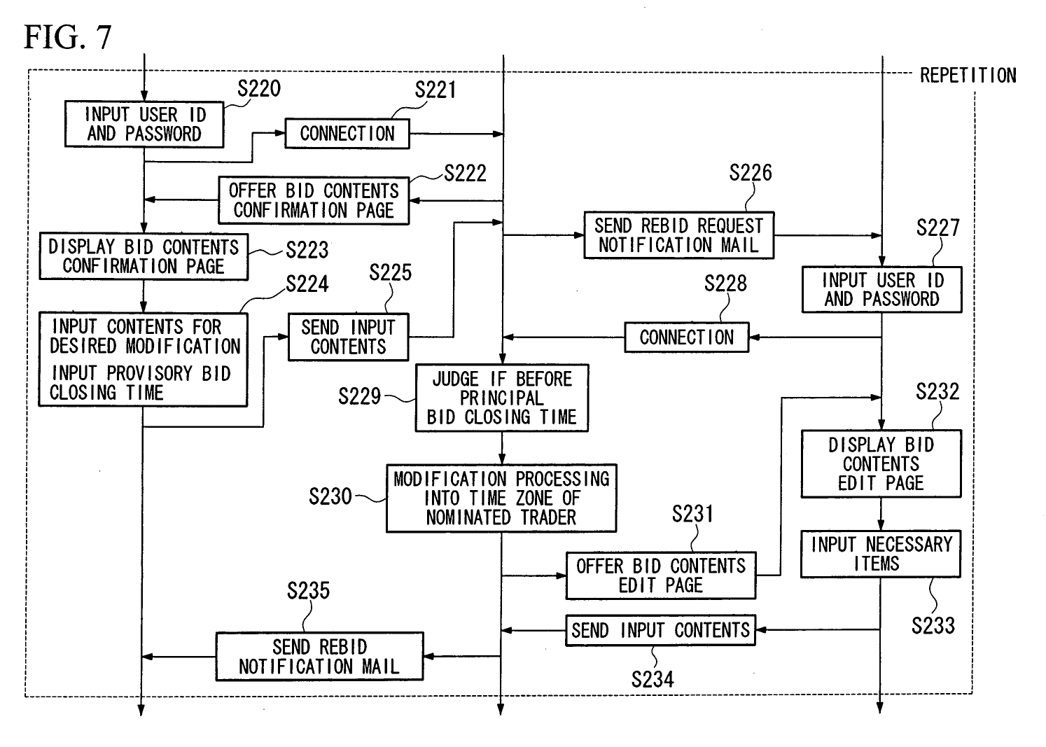

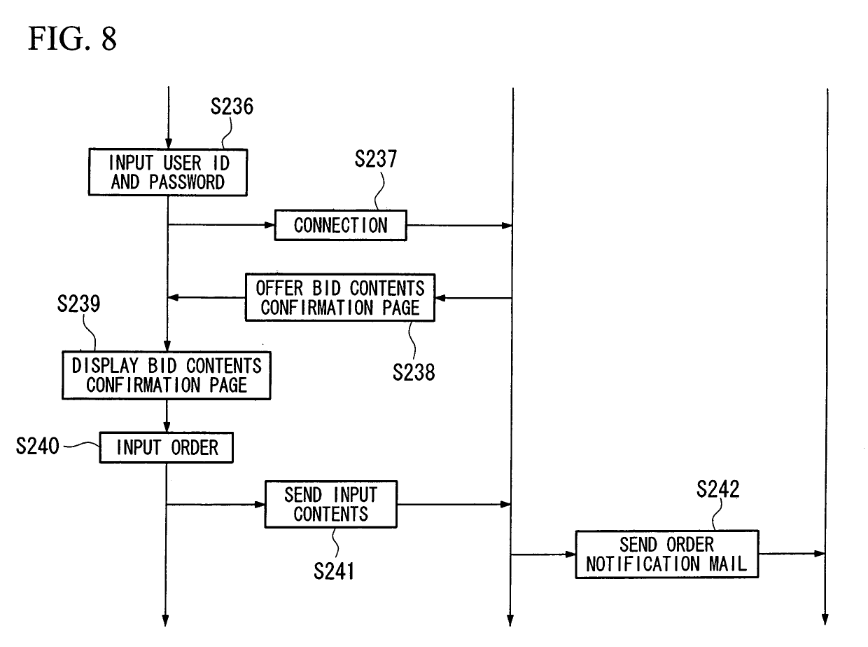

FIG. 5, FIG. 6, FIG. 7, and FIG. 8 are sequence diagrams showing flows of bid processing conducted in the electronic bidding system described above. In the description of sequences in FIG. 5, FIG. 6, FIG. 7, and FIG. 8, the description assumes that the buyer terminal is the buyer terminal 4a and the supplier terminal is the supplier terminal 5a. Even if the buyer terminal is another buyer terminal, the sequence diagram is substantially the same, and even if the supplier terminal is another supplier terminal, the sequence diagram is substantially the same.

Firstly, in the bid control system 3, when the bid request information obtaining section 32 obtains the bid request information passed from the bid request information collection system 2 (step S201), the mail notification section 35 sends the bid request information obtaining notification mail to the buyer included in the bid request information (step S202).

When the buyer receives the bid request information obtaining mail, the buyer inputs his/her user ID and password using the buyer terminal 4a (step S203). After this operation of the buyer, the buyer terminal 4a connects to the bid control system 3 (step S204).

The bid request edit page offering section 33 in the bid control system 3 offers the information related to the bid request edit page to the buyer terminal 4a that has connected to the bid control system 3 (step S205). Based on the information related to the bid request edit page offered by the bid control system 3, the buyer terminal 4a displays the bid request edit page shown as an example in FIG. 9, in the display section (step S206). The buyer uses the bid request edit page and inputs the necessary items such as principal bid closing time, provisory bid closing time, and the like, and then clicks the publish button (step S207). Then, when the buyer clicks the publish button, the edit contents are sent from the buyer terminal 4 to the bid control system 3 (step S208).

When the edit contents are received from the buyer terminal 4a, the bid control system 3 enables access to the bid request of one or a plurality of nominated traders included in the bid request information. That is, it publishes the bid request (step S209). It becomes impossible to edit the bid request even for the buyer after publishing. Subsequently, the mail notification section 35 sends the bid request notification mail to one or a plurality of nominated traders included in the bid request information obtained in step S101 (step S210).

When the nominated trader receives the bid request notification mail, the trader inputs his/her user ID (supplier ID) and password using the supplier terminal 5a (step S211). After this operation of the nominated trader, the supplier terminal 5a connects to the bid control system 3 (step S212).

In the bid control system 3, the bid closing time expired judgment section 36 judges if the time of the connection from the supplier terminal 5a was before the principal bid closing time appointed by the buyer using the bid request edit page, or not (step S213). In this sequence, it is judged to be before the principal bid closing time.

Based on the time zone code of the buyer and the time zone code of the nominated trader who has connected (time zone code stored by the supplier information storage section 31 related with the user ID (supplier ID) that the nominated trader input), the bid closing time computing section 37 computes the time in the time zone of the nominated trader for the provisory bid closing time appointed by the buyer using the bid request edit page (step S214). Subsequently, the bid request guide page offering section 38 offers the information related to the bid request guide page to the supplier terminal 5a that has connected to the bid control system 3 (step S215).

Based on the information related to the bid request guide page for editing offered by the bid control system 3, the supplier terminal 5a displays the bid request guide page for editing, shown as an example in FIG. 10 in the display section (step S216). Then, the nominated trader uses this bid request guide page for editing and inputs the necessary items for the bidding such as bid price or the like and clicks the bid button after the input up until the displayed bid closing time (time related to provisory bid closing time after modification into the time zone of the nominated trader) (step S217). When the nominated trader clicks the bid button, the input contents are sent from the supplier terminal 5a to the bid control system 3 (step S218).

When the input contents are received from the supplier terminal 5a in the bid control system 3, that is, when the nominated trader participates in the bidding, the bid notification mail is sent to the buyer (step S219).

When the buyer receives the bid notification mail, the buyer inputs his/her user ID and password using the buyer terminal 4a (step S220). After this operation of the buyer, the buyer terminal 4a connects to the bid control system 3 (step S221).

The bid contents confirmation page offering section 39 in the bid control system 3 offers the information related to the bid contents confirmation page to the buyer terminal 4a that has connected to the bid control system 3 (step S222).

Based on the information related to the bid contents confirmation page offered by the bid control system 3, the buyer terminal 4a displays the bid contents confirmation page shown as an example in FIG. 11 in the display section (step S223). The buyer refers to the bid contents confirmation page and examines the bid contents. In the examination, the buyer inputs comments related to desired modifications in the comment box, and inputs the provisory bid closing time in the input box (Submission Deadline) of the provisory bid closing time. After that, the buyer clicks the rebid request button (step S224). Then, when the buyer clicks the rebid request button, the input contents are sent from the buyer terminal 4a to the bid control system 3 (step S225).

Then, when the bid control system 3 receives the input contents from the buyer terminal 4a, the mail notification section 35 sends the rebid request notification mail to the nominated trader who conducted the bidding and who has become the target of the modification desired by the buyer (step S226).

When the nominated trader receives the rebid request notification mail, the trader inputs his/her user ID (supplier ID) and password using the supplier terminal 5a (step S227). After this operation of the nominated trader, the supplier terminal 5a connects to the bid control system 3 (step S228).

In the bid control system, the bid closing time expired judgment section 36 judges if the time of the connection from the supplier terminal 5a was before the principal bid closing time appointed by the buyer using the bid request edit page, or not (step S229). In this sequence, it is judged to be before the principal bid closing time.

Based on the time zone code of the buyer and the time zone code of the nominated trader who connected (time zone code stored by the supplier information store section 31 related with the user ID (supplier ID) that the nominated trader input), the bid closing time computing section 37 computes the time of the provisory bid closing time appointed by the buyer in the time zone of this nominated trader using the bid contents confirmation page (step S230).

Subsequently, the bid contents related page offering section 40 offers the information related to the bid contents edit page to the supplier terminal 5a that has connected to the bid control system 3 (step S231).

Based on the information related to the bid contents edit page offered by the bid control system 3, the supplier terminal 5a displays the bid contents edit page shown as an example in FIG. 12 in the display section (step S232). The nominated trader refers to this bid contents edit page and examines the contents of the desired modification of the buyer. In the examination, the nominated trader uses this bid contents edit page and inputs the necessary items such as bid price or the like and then clicks the rebid button after the input up until the displayed bid closing time (time related to provisory bid closing time after modification into the time zone of the nominated trader) (step S233). Then when the nominated trader clicks the rebid button, the input contents are sent from the supplier terminal 5a to the bid control system 3 (step S234).

When the input contents are accepted from the supplier terminal 5a in the bid control system 3, that is, when the nominated trader rebids, the mail notification section 35 sends the rebid notification mail to the buyer (step S235).

The step S220 to step S235 are appropriately repeated. Moreover, in the case where bidding satisfactory for the buyer is conducted in the first bidding, the processing from step S220 to step S235 is not conducted.

When the buyer receives the rebid notification mail (bid notification mail in some cases), the buyer inputs his/her user ID and password using the buyer terminal 4a (step S236). After this operation of the buyer, the buyer terminal 4a connects to the bid control system 3 (step S237).

The bid contents confirmation page offering section 39 in the bid control system 3 offers the information related to the bid contents confirmation page to the buyer terminal 4a that has connected to the bid control system 3 (step S238).

Based on the information related to the bid contents confirmation page offered by the bid control system 3, the buyer terminal 4a displays the bid contents confirmation page shown as an example in FIG. 10, in the display section (step S239). The buyer refers to the bid contents confirmation page and examines the bid contents. In the examination, if the buyer decides to order, he/she clicks the order button (step S240). Then, when the buyer clicks the order button, the input contents (order) are sent from the buyer terminal 4a to the bid control system 3 (step S241).

Then, if the bid control system 3 receives the input contents from the buyer terminal 4a, the mail notification section 35 sends the order notification mail to the nominated trader who conducted the bidding and who has become the target of the order (step S242).

According to the embodiments described above, based on the time zone code of time zone of the buyer and the time zone code of time zone of the nominated trader, the time of the provisory bid closing time appointed by the buyer in the time zone of the nominated trader is computed. Then, the computed time is shown as the bid closing time to the nominated trader. In this manner, since the bid closing time is displayed as the time in the nominated trader's own time zone, the nominated trader can be prevented from bidding after the bid closing time has past.

Moreover, the bid closing time shown to the nominated trader is the provisory bid closing time prior to the principal bid closing time at which the bidding is closed. As a result, there is a period from the time displayed to the nominated trader to the time when the bidding is closed, so that adjustment between the buyer and the nominated traders can be conducted to the last minute.

The bid control method may also be conducted by recording a program for realizing the functions of the processing section in FIG. 2 on a computer readable recording media, and reading in the program recorded on this recording media to a computer system and executing the program. ‘Computer system’ mentioned here is assumed to include the OS or the hardware of the peripherals. Moreover, ‘Computer system’ is assumed to include the WWW system comprising the homepage providing environment (or displaying environment). Furthermore, ‘computer readable recording media’ denotes a portable media such as a flexible disk, a magneto-optical disk, ROM, CD-ROM, or a storage device such as a harddisk built-in to the computer system. Furthermore, ‘computer readable recording media’ is assumed to include a media which holds the program for a fixed time such as with a volatile memory (RAM) inside of the computer system which becomes the sever or the client in the case where the program is sent via a network such as the Internet, or a communication line such as a telephone line.

Moreover, the above program may be transferred from the computer system that has stored this program in a storage device or the like, to another computer system via a transmission media or by transmission waves in the transmission media. Here, the ‘transmission media’ which transmits the program denotes a media having a function for transferring information, as with a network such as the Internet or a communication line such as a telephone line. Moreover, the above program may be for realizing a part of the functions described above. Furthermore, it may be a so called a differential file (differential program), whereby the functions described above can be realized by a combination of the programs that are already recorded in the computer system.

Preferred embodiments of the present invention have been described above. However the present invention is not limited to the above embodiments and various modifications are possible within the scope of the claims. For example, there is the case where the buyer appoints the principal bid closing time and the provisory bid closing time and shows the time of the appointed provisory bid closing time in the time zone of the nominated trader to the nominated trader. However, the present invention is not limited to this and it may be such that the buyer appoints only the principal bid closing time and shows the time of the appointed principal bid closing time in the time zone of the nominated trader to the nominated trader.

Moreover, there is the case where, when the provisory bid closing time is shown as the bid closing time to nominated trader, the time in the time zone code of the nominated trader is computed based on the time zone code of the buyer and the time zone code of nominated trader, and the computed time is shown to the nominated trader. However, it may be such that the provisory bid closing time appointed by the buyer is directly shown to the nominated trader (without the processing for modifying using the time zone code). In this manner, there is the effect that the buyer and the nominated traders can conduct the adjustment to the last minute in an electronic bidding system where the buyer and the nominated trader exist in the same time zone.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A bid control system connected to a buyer terminal on a buyer side and a supplier terminal on a supplier side via a network in order to control bidding, comprising:
a supplier information storage section storing an identifier for the supplier and a time zone for the supplier;
a bid request edit page offering section offering to said buyer terminal information related to a bid request edit page including a principal bid closing time as an input item;
a bid closing time computing section specifying a time zone for a nominated trader related with an identifier of the nominated trader by referring to storage information of said supplier information storage section, and computing a time of a principal bid closing time appointed by said buyer in the time zone for said nominated trader using said bid request edit page, based on the time zone for said nominated trader and the time zone for said buyer to whom said bid request edit page is offered by said bid request edit page offering section; and
a bid request guide page offering section offering to the supplier terminal of said nominated trader a bid request guide page in which a displayed bid closing time is the time computed by said bid closing time computing section.

2. The bid control system according to claim 1, wherein said bid request edit page further comprises:
a provisory bid closing time prior to said principal bid closing time, as an input item, and
said bid closing time computing section computing a time of said provisory bid closing time in the time zone for said nominated trader instead of said principal bid closing time.

3. A bid control method conducted in a bid control system connected to a buyer terminal on a buyer side and a supplier terminal on a supplier side via a network, comprising:
storing an identifier for the supplier and a time zone for said supplier;
offering to said storing terminal information related to a bid request edit page including a principal bid closing time as an input item;
specifying a time zone for a nominated trader related with an identifier of the nominated trader by referring to information stored in said supplier information storing step;
computing a time of the principal bid closing time appointed by said buyer in the time zone for said nominated trader using said bid request edit page, based on the time zone for said nominated trader and the time zone for said buyer to whom said bid request edit page is offered in said bid request edit page offering step; and
offering to the supplier terminal of said nominated trader a bid request guide page in which a displayed bid closing time is the time computed in said bid closing time computing step.

4. The bid control method according to claim 3, wherein said bid request edit page further includes a provisory bid closing time prior to said principal bid closing time, as an input item, and said computing a time of the principal bid closing time further comprises computing a time of said provisory bid closing time in the time zone for said nominated trader instead of said principal bid closing time.

5. A computer-readable medium on which is stored a set of instructions for controlling bidding in a bid control system connected to a buyer terminal on a buyer side and a supplier terminal on a supplier side via a network, which instructions when executed perform stages comprising:
storing an identifier for the supplier and a time zone for said supplier;
offering to said storing terminal information related to a bid request edit page including a principal bid closing time as an input item;
specifying a time zone for a nominated trader related with an identifier of the nominated trader by referring to information stored in said supplier information storing step;
computing a time of the principal bid closing time appointed by said buyer in the time zone for said nominated trader using said bid request edit page, based on the time zone for said nominated trader and the time zone for said buyer to whom said bid request edit page is offered in said bid request edit page offering step; and
offering to the supplier terminal of said nominated trader a bid request guide page in which a displayed bid closing time is the time computed in said bid closing time computing step.

6. The computer-readable medium according to claim 5, wherein said bid request edit page further includes a provisory bid closing time prior to said principal bid closing time, as an input item, and said computing a time of the principal bid closing time further comprises computing a time of said provisory bid closing time in the time zone for said nominated trader instead of said principal bid closing time.
